(19) United States
(12) Patent Application Publication
(10) Pub. No.: US 2015/0317176 A1
(43) Pub. Date: Nov. 5, 2015

(54) SYSTEMS AND METHODS FOR ENABLING VALUE ADDED SERVICES FOR EXTENSIBLE STORAGE DEVICES OVER A NETWORK VIA NVME CONTROLLER

(71) Applicant: CAVIUM, INC., San Jose, CA (US)

(72) Inventors: Muhammad Raghib HUSSAIN, Saratoga, CA (US); Vishal MURGAI, Cupertino, CA (US); Manojkumar PANICKER, Sunnyvale, CA (US); Faisal MASOOD, San Jose, CA (US); Brian FOLSOM, Northborough, MA (US); Richard Eugene KESSLER, Northborough, MA (US)

(21) Appl. No.: 14/473,111

(22) Filed: Aug. 29, 2014

Related U.S. Application Data
(60) Provisional application No. 61/987,956, filed on May 2, 2014.

(51) Int. Cl. G06F 9/455

(52) U.S. Cl. CPC G06F 9/45558; G06F 2009/45591; G06F 2009/45595; G06F 2009/45583

(57) ABSTRACT

A new approach is proposed that contemplates systems and methods to support a plurality of value-added services for storage operations on a plurality of remote storage devices virtualized as extensible/flexible storages and NVMe namespace(s) via an NVMe controller in real time. First, the NVMe controller virtualizes and presents the remote storage devices to one or more VMs running on a host attached to the NVMe controller as logical volumes so that each of the VMs running on the host can perform read/write operations on the emote storage devices as if they were local storage devices. The NVMe controller then monitors and meters the resources consumed by the activities/operations by the VMs to the virtualized remote storage devices as well as the data being transmitted during such operations in real time and creates analytics for billing purposes. In addition, the NVMe controller performs one or more of crypto operations, checksum operations, and compression and/or decompression operations on the data written to and/or read from the remote storage devices by the VMs as part of the value-added services to improve security, integrity, and efficient transmission of the data.

### CROSS-REFERENCE TO RELATED APPLICATIONS

This application claims the benefit of U.S. Provisional Patent Application No. 61/987,956, filed May 2, 2014 and entitled “Systems and methods for accessing extensible storage devices over a network as local storage via NVMe controller,” which is incorporated herein in its entirety by reference.

This application is related to co-pending U.S. patent application Ser. No. 14/279,712, filed May 16, 2014 and entitled “Systems and methods for NVMe controller virtualization to support multiple virtual machines running on a host,” which is incorporated herein in its entirety by reference.

This application is related to co-pending U.S. patent application Ser. No. 14/300,552, filed Jun. 10, 2014 and entitled “Systems and methods for enabling access to extensible storage devices over a network as local storage via NVMe controller,” which is incorporated herein in its entirety by reference.

This application is related to co-pending U.S. patent application Ser. No. 14/317,467, filed Jun. 27, 2014 and entitled “Systems and methods for enabling local caching for remote storage devices over a network via NVMe controller,” which is incorporated herein in its entirety by reference.

### BACKGROUND

Service providers have been increasingly providing their web services (e.g., web sites) at third party data centers in the cloud by running a plurality of virtual machines (VMs) on a host/server at the data center. Here, a VM is a software implementation of a physical machine (i.e. a computer) that executes programs to emulate an existing computing environment such as an operating system (OS). The VM runs on top of a hypervisor, which creates and runs one or more VMs on the host. The hypervisor presents each VM with a virtual operating platform and manages the execution of each VM on the host. By enabling multiple VMs having different operating systems to share the same host machine, the hypervisor leads to more efficient use of computing resources, both in terms of energy consumption and cost effectiveness, especially in a cloud computing environment.

Non-volatile memory express, also known as NVMe or NVM Express, is a specification that allows a solid-state drive (SSD) to make effective use of a high-speed Peripheral Component Interconnect Express (PCIe) bus attached to a computing device or host. Here the PCIe bus is a high-speed serial computer expansion bus designed to support hardware I/O virtualization and to enable maximum system bus throughput, low I/O pin count and small physical footprint for bus devices. NVMe typically operates on a non-volatile memory controller of the host, which manages the data stored on the non-volatile memory (e.g., SSD, SRAM, flash, HDD, etc.) and communicates with the host. Such an NVMe controller provides a command set and feature set for PCIe-based SSD access with the goals of increased and efficient performance and interoperability on a broad range of enterprise and client systems. The main benefits of using an NVMe controller to access PCIe-based SSDs are reduced latency, increased Input/Output (I/O) operations per second (IOPS) and lower power consumption, in comparison to Serial Attached SCSI (SAS)-based or Serial ATA (SATA)-based SSDs through the streamlining of the I/O stack.

Currently, a VM running on the host can access the PCIe-based SSDs via the physical NVMe controller attached to the host and the number of storage volumes the VM can access is constrained by the physical limitation on the maximum number of physical storage units/volumes that can be locally coupled to the physical NVMe controller. Since the VMs running on the host at the data center may belong to different web service providers and each of the VMs may have its own storage needs that may change in real time during operation and are thus unknown to the host, it is impossible to predict and allocate a fixed amount of storage volumes ahead of time for all the VMs running on the host that will meet their storage needs. Although enabling access to remote storage devices over a network can provide extensible/flexible storage volumes to the VMs during a storage operation, accessing those remote storage devices over the network could introduce data security, integrity, and transmission efficiency issues. It is also desirable to be able to monitor and analyze user's access to the remote storage devices for Service Level Agreement (SLA) and/or billing purposes.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system to support virtualization of remote storage devices to be presented as local storage devices to VMs in accordance with some embodiments.

FIG. 2 depicts an example of hardware implementation of the physical NVMe controller depicted in FIG. 1 in accordance with some embodiments.

FIG. 3 depicts a non-limiting example of a lookup table that maps between the NVMe namespaces of the logical volumes and the remote physical storage volumes in accordance with some embodiments.

FIG. 4A depicts a flowchart of an example of a process to support metering of data transmission between a VM and a plurality of remote storage devices via an NVMe controller in accordance with some embodiments.

FIG. 4B depicts a flowchart of an example of a process to support operations on data transmitted between a VM and a plurality of remote storage devices via an NVMe controller in accordance with some embodiments.

FIG. 5 depicts a non-limiting example of a diagram of a system to support virtualization of a plurality of remote storage devices to be presented as local storage devices to VMs, wherein the physical NVMe controller further includes a plurality of virtual NVMe controllers in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support a plurality of value-added services for storage operations on a plurality of remote storage devices virtualized as extensible/flexible storages and NVMe namespace(s) via an NVMe controller in real time. First, the NVMe controller virtualizes and presents the remote storage devices to one or more VMs running on a host attached to the NVMe controller as logical volumes so that each of the VMs running on the host can access these remote storage devices to perform read/write operations as if they were local storage devices via the NVMe namespace(s). The NVMe controller then monitors and meters resources (such as CPU, storage and network bandwidth) consumed by the activities/operations by the VMs to the virtualized remote storage devices as well as the data being transmitted during such operations in real time and creates analytics for billing purposes. In addition, the NVMe controller performs one or more of crypto operations, checksum operations, and compression and/or decompression operations on the data written to and/or read from the remote storage devices by the VMs as part of the value-added services to improve security, integrity, and efficient transmission of the data.

By virtualizing the remote storage devices as if they were local disks to the VMs and enabling the plurality of value-added services for accessing the virtualized remote storage devices, the proposed approach enables the VMs to have secured and fast access to extended storage units accessible over a network, removing any physical limitation on the number of storage volumes accessible by the VMs via the NVMe controller. In addition, by monitoring/metering the VMs' read/write operations to the remote storage devices in real time, the proposed approach enables collecting and creating analytics on user activities to the remote storage devices for billing based on the amount of data being transmitted by the read/write operations instead of or in addition to billing based on storage space occupied by the data. Such data metering-based billing is especially suitable for value-added services provisioned for the remote storage devices over the network where network bandwidth taken by the data is often a more critical metrics/bottleneck than the storage space occupied by the data.

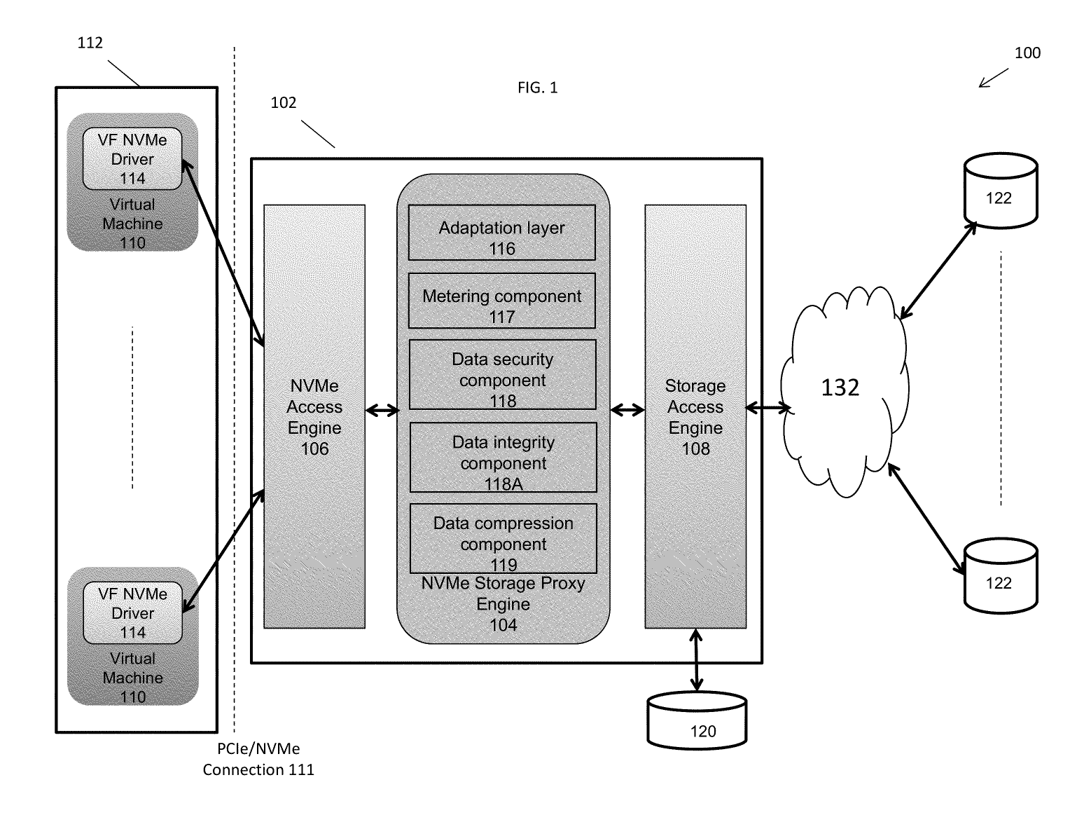

FIG. 1 depicts an example of a diagram of system 100 to support virtualization of remote storage devices to be presented as local storage devices to VMs. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

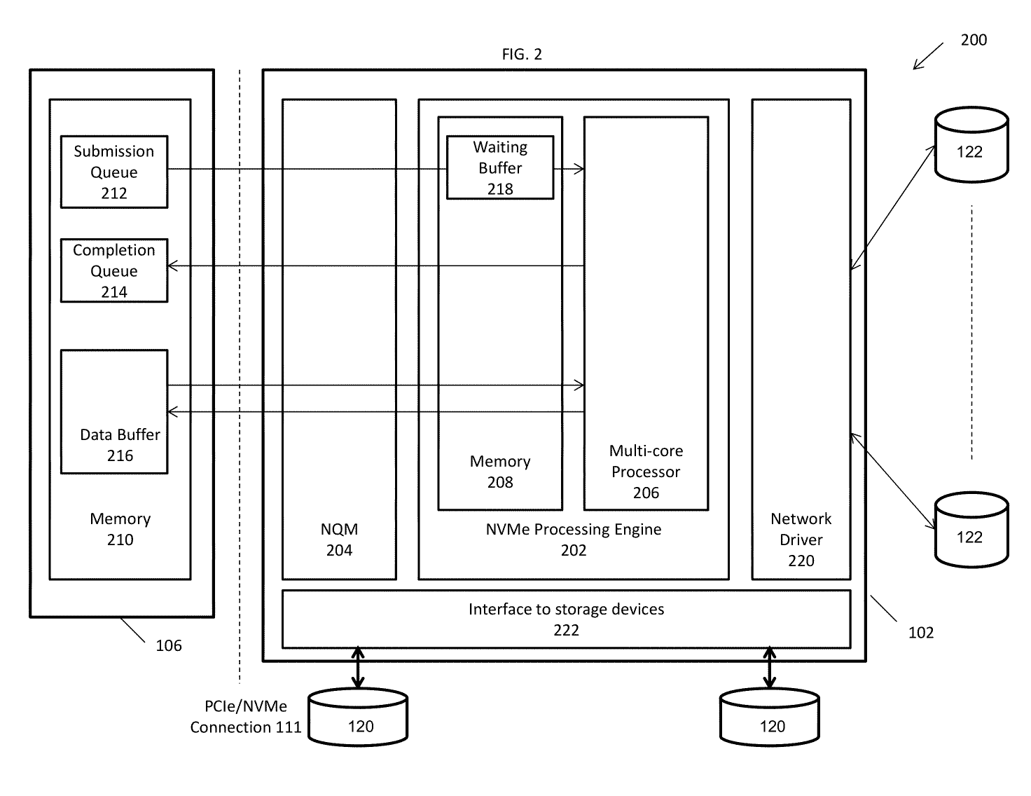

In the example of FIG. 1, the system 100 includes a physical NVMe controller 102 having at least an NVMe storage proxy engine 104, NVMe access engine 106 and a storage access engine 108 running on the NVMe controller 102. Here, the physical NVMe controller 102 is a hardware/firmware NVMe module having software, firmware, hardware, and/or other components that are used to effectuate a specific purpose. As discussed in details below, the physical NVMe controller 102 comprises one or more of a CPU or microprocessor, a storage unit or memory (also referred to as primary memory) such as RAM, with software instructions stored for practicing one or more processes. The physical NVMe controller 102 provides both Physical Functions (PFs) and Virtual Functions (VFs) to support the engines running on it, wherein the engines will typically include software instructions that are stored in the storage unit of the physical NVMe controller 102 for practicing one or more processes. As referred to herein, a PF function is a PCIe function used to configure and manage the single root I/O virtualization (SR-IOV) functionality of the controller such as enabling virtualization and exposing PCIe VFs, wherein a VF function is a lightweight PCIe function that supports SR-IOV and represents a virtualized instance of the controller 102. Each VF shares one or more physical resources on the physical NVMe controller 102, wherein such resources include but are not limited to on-controller memory 208, hardware processor 206, interface to storage devices 222, and network driver 220 of the physical NVMe controller 102 as depicted in FIG. 2 and discussed in details below.

In the example of FIG. 1, a computing unit/appliance/host 112 runs a plurality of VMs 110, each configured to provide a web-based service to clients over the Internet. Here, the host 112 can be a computing device, a communication device, a storage device, or any electronic device capable of running a software component. For non-limiting examples, a computing device can be, but is not limited to, a laptop PC, a desktop PC, a mobile device, or a server machine such as an x86/ARM server. A communication device can be, but is not limited to, a mobile phone.

In the example of FIG. 1, the host 112 is coupled to the physical NVMe controller 102 via a PCIe/NVMe link/connection 111 and the VMs 110 running on the host 112 are configured to access the physical NVMe controller 102 via the PCIe/NVMe link/connection 111. For a non-limiting example, the PCIe/NVMe link/connection 111 is a PCIe Gen3 x8 bus.

FIG. 2 depicts an example of hardware implementation 200 of the physical NVMe controller 102 depicted in FIG. 1. As shown in the example of FIG. 2, the hardware implementation 200 includes at least an NVMe processing engine 202, and an NVMe Queue Manager (NQM) 204 implemented to support the NVMe processing engine 202. Here, the NVMe processing engine 202 includes one or more CPUs/processors 206 (e.g., a multi-core/multi-threaded ARM/MIPS processor), and a primary memory 208 such as DRAM. The NVMe processing engine 202 is configured to execute all NVMe instructions/commands and to provide results upon completion of the instructions. The hardware-implemented NQM 204 provides a front-end interface to the engines that execute on the NVMe processing engine 202. In some embodiments, the NQM 204 manages at least a submission queue 212 that includes a plurality of administration and control instructions to be processed by the NVMe processing engine 202 and a completion queue 214 that includes status of the plurality of administration and control instructions that have been processed by the NVMe processing engine 202. In some embodiments, the NQM 204 further manages one or more data buffers 216 that include data read from or to be written to a storage device via the NVMe controllers 102. In some embodiments, one or more of the submission queue 212, completion queue 214, and data buffers 216 are maintained within memory 210 of the host 112. In some embodiments, the hardware implementation 200 of the physical NVMe controller 102 further includes an interface to storage devices 222, which enables a plurality of optional storage devices 120 to be coupled to and accessed by the physical NVMe controller 102 locally, and a network driver 220, which enables a plurality of storage devices 122 to be connected to the NVMe controller 102 remotely of a network.

In the example of FIG. 1, the NVMe access engine 106 of the NVMe controller 102 is configured to receive and manage instructions and data for read/write operations from the VMs 110 running on the host 102. When one of the VMs 110 running on the host 112 performs a read or write operation, it places a corresponding instruction in a submission queue 212, wherein the instruction is in NVMe format. During its operation, the NVMe access engine 106 utilizes the NQM 204 to fetch the administration and/or control commands from the submission queue 212 on the host 112 based on a “doorbell” of read or write operation, wherein the doorbell is generated by the VM 110 and received from the host 112. The NVMe access engine 106 also utilizes the NQM 204 to fetch the data to be written by the write operation from one of the data buffers 216 on the host 112. The NVMe access engine 106 then places the fetched commands in a waiting buffer 218 in the memory 208 of the NVMe processing engine 202 waiting for the NVMe Storage Proxy Engine 104 to process. Once the instructions are processed, The NVMe access engine 106 puts the status of the instructions back in the completion queue 214 and notifies the corresponding VM 110 accordingly. The NVMe access engine 106 also puts the data read by the read operation to the data buffer 216 and makes it available to the VM 110.

In some embodiments, each of the VMs 110 running on the host 112 has an NVMe driver 114 configured to interact with the NVMe access engine 106 of the NVMe controller 102 via the PCIe/NVMe link/connection 111. In some embodiments, each of the NVMe driver 114 is a virtual function (VF) driver configured to interact with the PCIe/NVMe link/connection 111 of the host 112 and to set up a communication path between its corresponding VM 110 and the NVMe access engine 106 and to receive and transmit data associated with the corresponding VM 110. In some embodiments, the VF NVMe driver 114 of the VM 110 and the NVMe access engine 106 communicate with each other through a SR-IOV PCIe connection as discussed above.

In some embodiments, the VMs 110 run independently on the host 112 and are isolated from each other so that one VM 110 cannot access the data and/or communication of any other VMs 110 running on the same host. When transmitting commands and/or data to and/or from a VM 110, the corresponding VF NVMe driver 114 directly puts and/or retrieves the commands and/or data from its queues and/or the data buffer, which is sent out or received from the NVMe access engine 106 without the data being accessed by the host 112 or any other VMs 110 running on the same host 112.

In the example of FIG. 1, the storage access engine 108 of the NVMe controller 102 is configured to access and communicate with a plurality of non-volatile disk storage devices/units, wherein each of the storage units is either (optionally) locally coupled to the NVMe controller 102 via the interface to storage devices 222 (e.g., local storage devices 120), or remotely accessible by the physical NVMe controller 102 over a network 132 (e.g., remote storage devices 122) via the network communication interface/driver 220 following certain communication protocols such as TCP/IP protocol. As referred to herein, each of the locally attached and remotely accessible storage devices can be a non-volatile (non-transient) storage device, which can be but is not limited to, a solid-state drive (SSD), a static random-access memory (SRAM), a magnetic hard disk drive (HDD), and a flash drive. The network 132 can be but is not limited to, internet, intranet, wide area network (WAN), local area network (LAN), wireless network, Bluetooth, WiFi, mobile communication network, or any other network type. The physical connections of the network and the communication protocols are well known to those of skill in the art.

In the example of FIG. 1, the NVMe storage proxy engine 104 of the NVMe controller 102 is configured to collect volumes of the remote storage devices accessible via the storage access engine 108 over the network under the storage network protocol and convert the storage volumes of the remote storage devices to one or more NVMe namespaces each including a plurality of logical volumes (a collection of logical blocks) to be accessed by VMs 110 running on the host 112. As such, the NVMe namespaces may cover both the storage devices locally attached to the NVMe controller 102 and those remotely accessible by the storage access engine 108 under the storage network protocol. The storage network protocol is used to access a remote storage device accessible over the network, wherein such storage network protocol can be but is not limited to Internet Small Computer System Interface (iSCSI). iSCSI is an Internet Protocol (IP)-based storage networking standard for linking data storage devices by carrying SCSI commands over the networks. By enabling access to remote storage devices over the network, iSCSI increases the capabilities and performance of storage data transmission over local area networks (LANs), wide area networks (WANs), and the Internet.

In some embodiments, the NVMe storage proxy engine 104 organizes the remote storage devices as one or more logical or virtual volumes/blocks in the NVMe namespaces, to which the VMs 110 can access and perform I/O operations as if they were local storage volumes. Here, each volume is classified as logical or virtual since it maps to one or more physical storage devices either locally attached to or remotely accessible by the NVMe controller 102 via the storage access engine 108. In some embodiments, multiple VMs 110 running on the host 112 are enabled to access the same logical volume or virtual volume and each logical/virtual volume can be shared among multiple VMs.

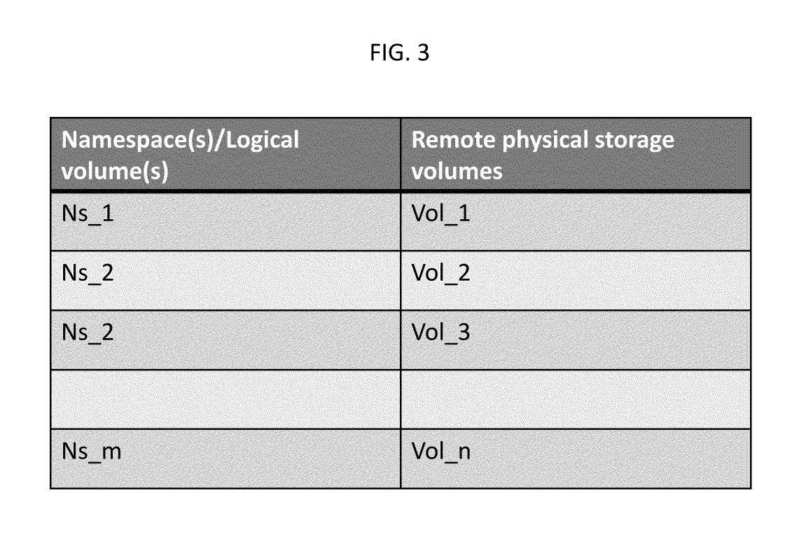

In some embodiments, the NVMe storage proxy engine 104 establishes a lookup table that maps between the NVMe namespaces of the logical volumes, Ns_{—}1, . . . , Ns_m, and the remote physical storage devices/volumes, Vol_{—}1, . . . , Vol_n, accessible over the network as shown by the non-limiting example depicted in FIG. 3. Here, there is a multiple-to-multiple correspondence between the NVMe namespaces and the physical storage volumes, meaning that one namespace (e.g., Ns_{—}2) may correspond to a logical volume that maps to a plurality of remote physical storage volumes (e.g., Vol_{—}2 and Vol_{—}3), and a single remote physical storage volume may also be included in a plurality of logical volumes and accessible by the VMs 110 via their corresponding NVMe namespaces. In some embodiments, the NVMe storage proxy engine 104 is configured to expand the mappings between the NVMe namespaces of the logical volumes and the remote physical storage devices/volumes to add additional storage volumes on demand. For a non-limiting example, when at least one of the VMs 110 running on the host 112 requests for more storage volumes, the NVMe storage proxy engine 104 may expand the namespace/logical volume accessed by the VM to include additional remote physical storage devices.

In some embodiments, the NVMe storage proxy engine 104 further includes an adaptation layer/shim 116, which is a software component configured to manage message flows between the NVMe namespaces and the remote physical storage volumes. Specifically, when instructions for storage operations (e.g., read/write operations) on one or more logical volumes/namespaces are received from the VMs 110 via the NVMe access engine 106, the adaptation layer/shim 116 converts the instructions under NVMe specification to one or more corresponding instructions on the remote physical storage volumes under the storage network protocol such as iSCSI according to the lookup table. Conversely, when results and/or feedbacks on the storage operations performed on the remote physical storage volumes are received via the storage access engine 108, the adaptation layer/shim 116 also converts the results to feedbacks about the operations on the one or more logical volumes/namespaces and provides such converted results to the VMs 110.

In the example of FIG. 1, the NVMe access engine 106 of the NVMe controller 102 is configured to export and present the NVMe namespaces and logical volumes of the remote physical storage devices 122 to the VMs 110 running on the host 112 as accessible storage devices that are no different from those locally connected storage devices 120. The actual mapping, expansion, and operations on the remote storage devices 122 over the network using iSCSI-like storage network protocol performed by the NVMe controller 102 are transparent to the VMs 110, enabling the VMs 110 to provide the instructions through the NVMe access engine 106 to perform one or more read/write operations on the logical volumes that map to the remote storage devices 122.

In some embodiments, the NVMe storage proxy engine 104 is configured to support a plurality of value-added services to the user of the VMs 110 by performing a plurality of operations on the data being transmitted through the NVMe controller 102 as discussed in details below. In some embodiments, the NVMe storage proxy engine 104 is configured to provision the plurality of value-added services according to a service-level agreement (SLA), which is a service contract that formally defines types, levels, and timings of the services provided by a storage service provider to a user of the VM 110. For non-limiting examples, the plurality of value-added services include but are not limited to, billing based on network usage, storage data security, integrity, and efficient delivery.

Unlike read/write operations to local storage devices 120, where storage capacities of the devices are the only constraint, read/write operations on the logical volumes that map to the remote storage devices over the network are often constrained by the network bandwidth between the VMs 110 and to the remote storage devices 122 in addition to the physical limitations on the capacities of the remote storage devices 122. In the example of FIG. 1, the NVMe storage proxy engine 104 further includes a metering component 117 configured to monitor and meter the number of the read/write operations performed by each of the VMs 110 and/or the amount of data being transmitted (read from and/or written to) between the VMs 110 and the remote storage devices 122 as a result of the read/write operations in real time. Such metered amount of data transmission between the VMs 110 and the remote storage devices 122 can then be utilized to determine the network bandwidth consumed by each of the VMs 110 during the read/write operations in addition to the storage space occupied by the data on the remote storage devices 122 and enable a storage service provider to bill the users of the VMs 110 based on their dynamic network bandwidth usage in terms of the amount of their data transmission in addition to or instead of their storage space consumption.

In some embodiments, the metering component 117 of the NVMe storage proxy engine 104 is further configured to generate analytics on the read/write operations by a VM 110 based on the amount of the data transmitted and metered using various analytical approaches that include but are not limited to statistics, operations research, and mathematical algorithms. In some embodiments, the analytics generated by the metering component 117 reveal meaningful patterns of storage access and data transmission by the VM 110 in terms of various metrics such as amount and timing of peak and/or data average usage, logical volumes most and/or least frequently accessed by the VM 110, and timing and/or frequencies of such access by the read/write operations of the VM 110, etc. In some embodiments, the NVMe access engine 106 is configured to present the identified patterns in the analytics of the VM 110 to its user in the form of a multi-dimensional representation, wherein each dimension of the multi-dimensional representation represents one of the metrics measured above. Such patterns identified in the analytics by the metering component 117 provide real time information and insights on users/applications activities in terms of the read/write operations by the VMs 110 and enables a service provider to dynamically customize its services and/or billing policies to better serve the user in real time via the NVMe storage proxy engine 104. For a non-limiting example, the NVMe storage proxy engine 104 may adjust the allocation of network bandwidth for the VM 110 dynamically in real time based on the pattern of its data transmission to the remote storage devices 122 over the network. For another non-limiting example, the NVMe storage proxy engine 104 is configured to pre-fetch data from a volume of the remote storage devices 122 that are most frequently accessed by the VM 110 to a cache (e.g., memory 208) locally associated with the NVMe controller 102 in anticipation of the next read operation by the VM 110 and delete a volume least frequently requested by the VM 110 from the local cache if the cache is close to being fully occupied.

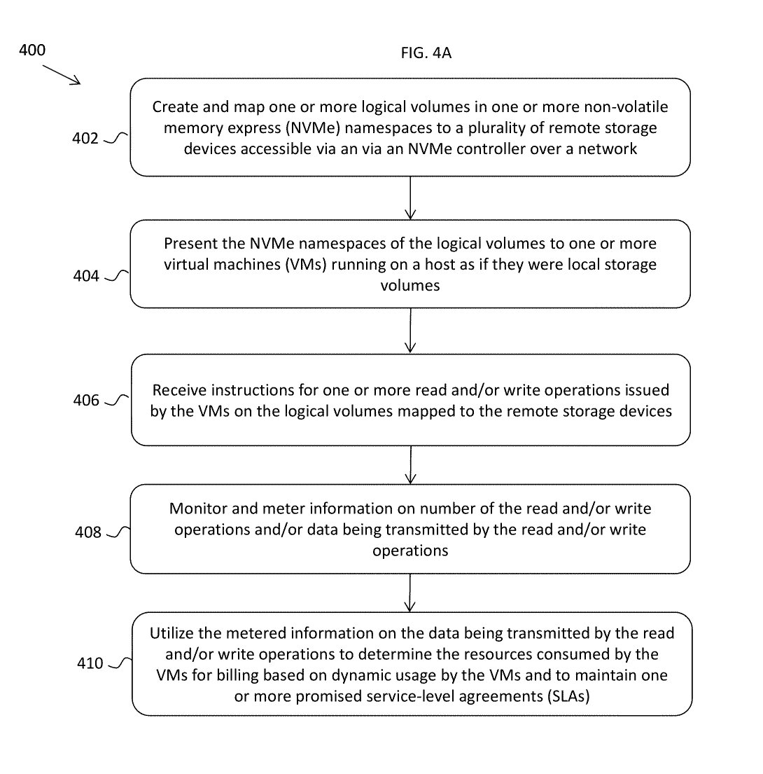

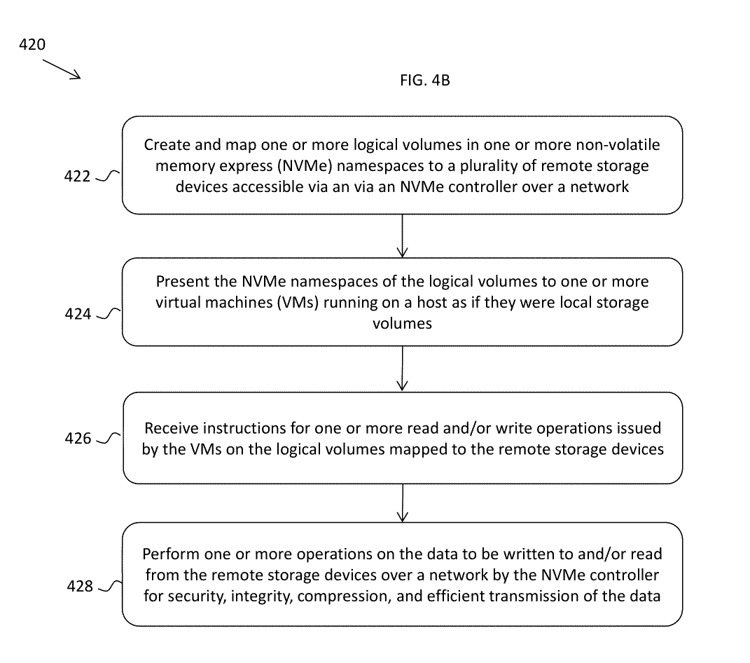

FIG. 4A depicts a flowchart of an example of a process to support metering of data transmission between a VM and a plurality of remote storage devices via an NVMe controller. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 4A, the flowchart 400 starts at block 402, where one or more logical volumes in one or more NVMe namespaces are created and mapped to a plurality of remote storage devices accessible over a network via an NVMe controller. The flowchart 400 continues to block 404, where the NVMe namespaces of the logical volumes mapped to the remote storage devices are presented to one or more virtual machines (VMs) running on a host as if they were local storage volumes. The flowchart 400 continues to block 406, wherein instructions for one or more read and/or write operations issued by the VMs on the logical volumes mapped to the remote storage devices are received. The flowchart 400 continues to block 408, where information on number of the read and/or write operations and/or data being transmitted by the read and/or write operations are metered and monitored. The flowchart 400 ends at block 410, where the metered information on the data being transmitted by the read and/or write operations is utilized to determine the resources consumed by the VMs for billing based on dynamic usage by the VMs and to maintain one or more service-level agreements (SLAs) promised to the users of the VMs.

In some embodiments, the NVMe storage proxy engine 104 further includes a data security component 118, which is a security layer on top of the adaptation layer/116 and is configured to perform crypto operations to encrypt data to be written by the write operations before the data is transmitted to the remote storage devices 122 and to decrypt data read by the read operations from the remote storage devices 122 before it is provided to the VMs 110. The remote storage devices 122 are configured to perform the corresponding decryption and/or encryption operations on the data encrypted and/or decrypted by the data security component 118 of the NVMe storage proxy engine 104 using the same set of encryption keys. In some embodiments, the data security component 118 is configured to offload the crypto operations to components of the physical NVMe controller 102 (e.g., NVMe processing engine 202), which utilizes both hardware and embedded software to implement the security algorithms to accelerate the crypto operations so that the crypto operations would not introduce any latency into the data transmission between the VMs 110 and the remote storage devices 122 through the NVMe storage proxy engine 104. In some embodiments, the data security component 118 is configured to maintain keys used for the crypto operations in a secured environment on components of the physical NVMe controller 102 (e.g., memory 208), wherein access to the keys is restricted to the VM 110 issuing the instructions for the read/write operations and the data security component 118 only while no other VM 110 is allowed access to the keys. In some embodiments, the VM 110 and the data security component 118 are required to mutually authenticate each other via, for a non-limiting example, exchange of a shared secret, before being able to access the keys for the crypto operations.

In some embodiments, the NVMe storage proxy engine 104 further includes a data integrity component 118A, which is configured to perform checksum operations on data being transmitted between the VMs 110 and the remote storage devices 122 during the read/write operations for data integrity. For a non-limiting example, the checksum operations can be cyclic redundancy check (CRC) operations such as CRC-16 that check against accidental change in the data being transmitted. During a read operation, the data security component 118 performs a checksum operation on each data block/packet being transmitted from the remote storage devices 122 and attaches a value (e.g., a CRC-16 value) of the checksum operation to the data block in, for a non-limiting example, a data integrity field (DIF) following T10-DIF standard. When the host 112 of the VM 110 receives the data block from the NVMe storage proxy engine 104, the host 112 will then retrieve the value from the DIF of the received data block and compare it with its own calculated value by running CRC-16 operations on the received data block. During a write operation, the host 112 of the VMs 110 calculates a value based on a checksum operation on each data block to be written to remote storage devices 122 and attaches the checksum value to the data block based on standards. The data integrity component 118A of the NVMe storage proxy engine 104 will then compare and verify the checksum value based on the value stored on the physical NVMe controller 102 before transmitting and writing the data block to the remote storage devices 122. In some embodiments, the data integrity component 118A is configured to offload the checksum operations to components of the physical NVMe controller 102 (e.g., NVMe processing engine 202), which utilizes both hardware and embedded software to accelerate the checksum operations and free up host CPU cycles so that the operations would not introduce any latency into the data transmission between the VMs 110 and the remote storage devices 122 through the NVMe storage proxy engine 104. In some embodiments, the data integrity component 118A is configured to maintain the values used in the checksum operations in a secured environment on components of the physical NVMe controller 102 (e.g., memory 208).

In some embodiments, the NVMe storage proxy engine 104 further includes a data compression component 119 configured to compress data to be written to and decompress data read from the remote storage devices 122. The remote storage devices 122 are configured to decompress and/or compress the data compressed and/or decompressed by the data compression component 119 of the NVMe storage proxy engine 104 using the same compression/decompression approaches. Compressing data to be written to the remote storage devices 122 not only reduces the storage space to be consumed on the remote storage devices 122, but also reduces the network bandwidth required for transmitting the data, which is critical when a large amount of data is to be transmitted by multiple VMs at the same time. In some embodiments, the data compression component 119 is configured to offload its data compression and decompression operations to components of the physical NVMe controller 102 (e.g., NVMe processing engine 202), which utilizes both hardware and embedded software to accelerate the operations so that the operations would not introduce any latency into the data transmission between the VMs 110 and the remote storage devices 122 through the NVMe storage proxy engine 104.

FIG. 4B depicts a flowchart of an example of a process to support operations on data transmitted between a VM and a plurality of remote storage device via an NVMe controller. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 4B, the flowchart 420 starts at block 422, where one or more logical volumes in one or more NVMe namespaces are created and mapped to a plurality of remote storage devices accessible over a network via an NVMe controller. The flowchart 420 continues to block 424, where the NVMe namespaces of the logical volumes mapped to the remote storage devices are presented to one or more virtual machines (VMs) running on a host as if they were local storage volumes. The flowchart 420 continues to block 426, where instructions for one or more read and/or write operations issued by the VMs on the logical volumes mapped to the remote storage devices are received. The flowchart 420 ends at block 428, where one or more operations are performed on the data to be written to and/or read from the remote storage devices over a network by the NVMe controller for security, integrity, compression, and efficient transmission of the data.

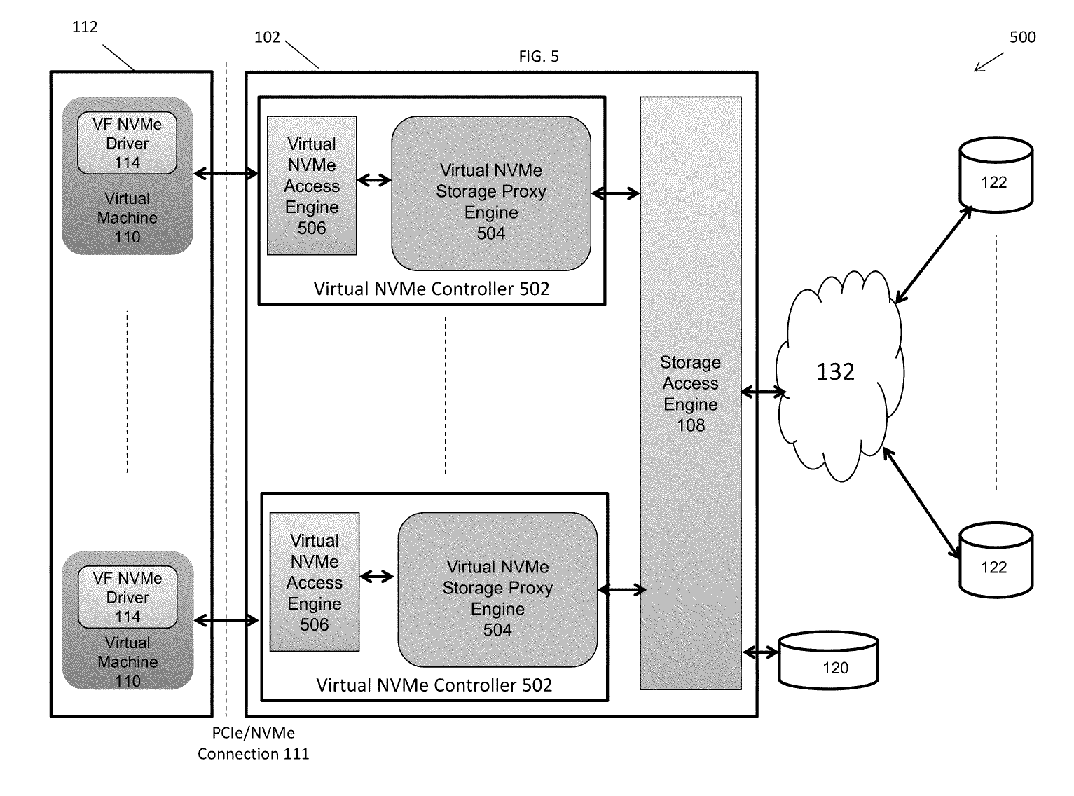

FIG. 5 depicts a non-limiting example of a diagram of system 500 to support virtualization of remote storage devices as local storage devices for VMs, wherein the physical NVMe controller 102 further includes a plurality of virtual NVMe controllers 502. In the example of FIG. 5, the plurality of virtual NVMe controllers 502 run on the single physical NVMe controller 102 where each of the virtual NVMe controllers 502 is a hardware accelerated software engine emulating the functionalities of an NVMe controller to be accessed by one of the VMs 110 running on the host 112. In some embodiments, the virtual NVMe controllers 502 have a one-to-one correspondence with the VMs 110, wherein each virtual NVMe controller 104 interacts with and allows access from only one of the VMs 110. Each virtual NVMe controller 104 is assigned to and dedicated to support one and only one of the VMs 110 to access its storage devices, wherein any single virtual NVMe controller 104 is not shared across multiple VMs 110.

In some embodiments, each virtual NVMe controller 502 is configured to support identity-based authentication and access from its corresponding VM 110 for its operations, wherein each identity permits a different set of API calls for different types of commands/instructions used to create, initialize and manage the virtual NVMe controller 502, and/or provide access to the logic volume for the VM 110. In some embodiments, the types of commands made available by the virtual NVMe controller 502 vary based on the type of user requesting access through the VM 110 and some API calls do not require any user login. For a non-limiting example, different types of commands can be utilized to initialize and manage virtual NVMe controller 502 running on the physical NVMe controller 102.

As shown in the example of FIG. 5, each virtual NVMe controller 502 may further include a virtual NVMe storage proxy engine 504 and a virtual NVMe access engine 506, which function in a similar fashion as the respective NVMe storage proxy engine 104 and a NVMe access engine 106 discussed above. In some embodiments, the virtual NVMe storage proxy engine 504 in each virtual NVMe controller 502 is configured to access both the locally attached storage devices 120 and remotely accessible storage devices 122 via the storage access engine 108, which can be shared by all the virtual NVMe controllers 502 running on the physical NVMe controller 102.

During operation, each virtual NVMe controller 502 creates and maps one or more logical volumes in one or more NVMe namespaces mapped to a plurality of remote storage devices accessible over a network. Each virtual NVMe controller 502 then presents the NVMe namespaces of the logical volumes to its corresponding VM 110 as if they were local storage volumes. When the VM 110 performs read/write operations on the logical volumes, the virtual NVMe controller 502 monitors and meters the number of the read/write operations and the amount of data being transmitted as a result of the read/write operations. The virtual NVMe controller 502 is further configured to perform a plurality of operations on the data being transmitted for data security, integrity, and transmission efficiency as part of the value-added services provided to the user of the VM 110.

In some embodiments, each virtual NVMe controller 502 depicted in FIG. 5 has one or more pairs of submission queue 212 and completion queue 214 associated with it, wherein each queue can accommodate a plurality of entries of instructions from one of the VMs 110. As discussed above, the instructions in the submission queue 212 are first fetched by the NQM 204 from the memory 210 of the host 112 to the waiting buffer 218 of the NVMe processing engine 202 as discussed above. During its operation, each virtual NVMe controller 502 retrieves the instructions from its corresponding VM 110 from the waiting buffer 218 and converts the instructions according to the storage network protocol in order to perform a read/write operation on the data stored on the local storage devices 120 and/or remote storage devices 122 over the network by invoking VF functions provided by the physical NVMe controller 102. During the operation, data is transmitted to or received from the local/remote storage devices in the logical volume of the VM 110 via the interface to storage access engine 108. Once the operation has been processed, the virtual NVMe controller 502 saves the status of the executed instructions in the waiting buffer 218 of the processing engine 202, which are then placed into the completion queue 214 by the NQM 204. The data being processed by the instructions of the VMs 110 is also transferred between the data buffer 216 of the memory 210 of the host 112 and the memory 208 of the NVMe processing engine 202.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support metering of data transmission with virtualized remote storages, comprising:
an NVMe access engine running on the physical NVMe controller, which in operation, is configured to
present one or more logical volumes mapped to a plurality of remote storage devices to one or more virtual machines (VMs) running on a host as if they were local storage volumes;
receive instructions for one or more read and/or write operations issued by the VMs on the logical volumes mapped to the remote storage devices;
a non-volatile memory express (NVMe) storage proxy engine running on a physical NVMe controller, which in operation, is configured to:
create and map said logical volumes in the NVMe namespaces to the remote storage devices accessible via the NVMe controller over a network;
monitor and meter information on number of the read and/or write operations and/or data being transmitted by the read and/or write operations;
utilize the metered information on the data being transmitted by the read and/or write operations to determine resources consumed by the VMs for billing based on dynamic usage by the VMs and to maintain one or more promised service-level agreements (SLAs).

2. The system of claim 1, wherein:
the host of the VMs is an x86/ARM server.

3. The system of claim 1, wherein:
the logical volume further includes storage devices attached to the physical NVMe controller locally.

4. The system of claim 1, wherein:
the physical NVMe controller connects to the host via a Peripheral Component Interconnect Express (PCIe)/NVMe link.

5. The system of claim 1, wherein:
the NVMe storage proxy engine is configured to enable multiple of the plurality of VMs to access the same logical volume and each logical volume is enabled to be shared among the multiple VMs.

6. The system of claim 1, wherein:
the NVMe storage proxy engine is configured to expand mappings between the NVMe namespaces of the logical volumes and the remote physical storage devices/volumes to add additional storage volumes on demand.

7. The system of claim 1, wherein:
the resources include one or more of CPU, storage, and network bandwidth.

8. The system of claim 1, wherein:
the NVMe storage proxy engine is configured to generate analytics on the read/write operations by the VMs based on the amount of the data transmitted and metered, wherein the analytics reveals one or more patterns of data transmission by the VMs.

9. The system of claim 8, wherein:
the NVMe access engine is configured to present the identified patterns in the analytics to a user of the VMs in the form a multi-dimensional representation, wherein each dimension of the multi-dimensional representation represents a metric of the analytics.

10. The system of claim 8, wherein:
the NVMe storage proxy engine is configured to adjust allocation of network bandwidth for the VMs dynamically in real time based on the pattern of data transmission to the remote storage devices over the network.

11. The system of claim 8, wherein:
the NVMe storage proxy engine is configured to pre-fetch data from a volume of the remote storage devices that are most frequently accessed by the VMs to a cache locally associated with the NVMe controller in anticipation of the next read operation by the VMs.

12. A system to support operations on data transmitted with virtualized remote storages, comprising:
an NVMe access engine running on the physical NVMe controller, which in operation, is configured to
present one or more logical volumes mapped to a plurality of remote storage devices to one or more virtual machines (VMs) running on a host as if they were local storage volumes;
receive instructions for one or more read and/or write operations issued by the VMs on the logical volumes mapped to the remote storage devices;
a non-volatile memory express (NVMe) storage proxy engine running on a physical NVMe controller, which in operation, is configured to:
create and map said logical volumes in the NVMe namespaces to the remote storage devices accessible via the NVMe controller over a network;
perform one or more operations on the data to be written to and/or read from the remote storage devices over a network by the NVMe controller for security, integrity, compression, and efficient transmission of the data.

13. The system of claim 12, wherein:
the NVMe storage proxy engine is configured to provision the one or more operations on the data as one or more valued-added services under a service-level agreement (SLA).

14. The system of claim 12, wherein:
the NVMe storage proxy engine is configured to perform crypto operations to encrypt data to be written by the write operations before the data is transmitted to the remote storage devices and to decrypt data read by the read operations from the remote storage devices before the data is provided to the VMs.

15. The system of claim 14, wherein:
the NVMe storage proxy engine is configured to offload the crypto operations to components of the physical NVMe controller to accelerate the crypto operations without introducing latency into the data transmission between the VMs and the remote storage devices.

16. The system of claim 14, wherein:
the NVMe storage proxy engine is configured to maintain keys used for the crypto operations in a secured environment on components of the physical NVMe controller, wherein access to the keys is restricted to the VM issuing the instructions for the read/write operations while no other VM is allowed access to the keys.

17. The system of claim 12, wherein:
the NVMe storage proxy engine is configured to perform checksum operations on data transmitted between the VMs and the remote storage devices during the read/write operations for data integrity.

18. The system of claim 17, wherein:
the NVMe storage proxy engine is configured to offload the checksum operations to components of the physical NVMe controller, which utilizes both hardware and embedded software to accelerate the checksum operations without introducing latency into the data transmission between the VMs and the remote storage devices.

19. The system of claim 12, wherein:
the NVMe storage proxy engine is configured to compress data to be written to and decompress data read from the remote storage devices.

20. The system of claim 19, wherein:
the NVMe storage proxy engine is configured to offload the data compression and decompression operations to components of the physical NVMe controller, which utilizes both hardware and embedded software to accelerate the operations without introducing latency into the data transmission between the VMs and the remote storage devices.

21. A computer-implemented method to support metering of data transmission with virtualized remote storages via a non-volatile memory express (NVMe) controller, comprising:
creating and mapping one or more logical volumes in one or more NVMe namespaces to a plurality of remote storage devices accessible via the NVMe controller over a network;
presenting the NVMe namespaces of the logical volumes to one or more virtual machines (VMs) running on a host as if they were local storage volumes;
receiving instructions for one or more read and/or write operations issued by the VMs on the logical volumes mapped to the remote storage devices;
monitoring and metering information on number of the read and/or write operations and/or data being transmitted by the read and/or write operations;
utilizing the metered information on the data being transmitted by the read and/or write operations to determine resources consumed by the VMs for billing based on dynamic usage by the VMs and to maintain one or more promised service-level agreements (SLAs).

22. The method of claim 21, further comprising:
enabling multiple of the plurality of VMs to access the same logical volume and each logical volume is enabled to be shared among the multiple VMs.

23. The method of claim 21, further comprising:
expanding mappings between the NVMe namespaces of the logical volumes and the remote physical storage devices/volumes to add additional storage volumes on demand.

24. The method of claim 21, further comprising:
provisioning the billing based on network usage as a valued-added service under the SLAs.

25. The method of claim 21, further comprising:
generating analytics on the read/write operations by the VMs based on the amount of the data transmitted and metered, wherein the analytics reveals one or more patterns of data transmission by the VMs.

26. The method of claim 25, further comprising:
presenting the identified patterns in the analytics to a user of the VMs in the form a multi-dimensional representation, wherein each dimension of the multi-dimensional representation represents a metric of the analytics.

27. The method of claim 25, further comprising:
adjusting allocation of network bandwidth for the VMs dynamically in real time based on the pattern of data transmission to the remote storage devices over the network.

28. The method of claim 25, further comprising:
pre-fetching data from a volume of the remote storage devices that are most frequently accessed by the VMs to a cache locally associated with the NVMe controller in anticipation of the next read operation by the VMs.

29. A computer-implemented method to support operations on data transmitted with virtualized remote storages via a non-volatile memory express (NVMe) controller, comprising:
creating and mapping one or more logical volumes in one or more NVMe namespaces to a plurality of remote storage devices accessible via the NVMe controller over a network;
presenting the NVMe namespaces of the logical volumes to one or more virtual machines (VMs) running on a host as if they were local storage volumes;
receiving instructions for one or more read and/or write operations issued by the VMs on the logical volumes mapped to the remote storage devices;
performing one or more operations on the data to be written to and/or read from the remote storage devices over a network by the NVMe controller for security, integrity, compression, and efficient transmission of the data.

30. The method of claim 29, further comprising:
provisioning the one or more operations on the data as one or more valued-added services under a service-level agreement (SLA).

31. The method of claim 29, further comprising:
performing crypto operations to encrypt data to be written by the write operations before the data is transmitted to the remote storage devices and to decrypt data read by the read operations from the remote storage devices before the data is provided to the VMs.

32. The method of claim 31, further comprising:
offloading the crypto operations to components of the physical NVMe controller to accelerate the crypto operations without introducing latency into the data transmission between the VMs and the remote storage devices.

33. The method of claim 31, further comprising:
maintaining keys used for the crypto operations in a secured environment on components of the physical NVMe controller, wherein access to the keys is restricted to the VM issuing the instructions for the read/write operations while no other VM is allowed access to the keys.

34. The method of claim 29, further comprising:
performing checksum operations on data transmitted between the VMs and the remote storage devices during the read/write operations for data integrity.

35. The method of claim 34, further comprising:
offloading the checksum operations to components of the physical NVMe controller, which utilizes both hardware and embedded software to accelerate the checksum operations without introducing latency into the data transmission between the VMs and the remote storage devices.

36. The method of claim 29, further comprising:
compressing data to be written to and decompress data read from the remote storage devices.

37. The method of claim 36, further comprising:
offloading the data compression and decompression operations to components of the physical NVMe controller, which utilizes both hardware and embedded software to accelerate the operations without introducing latency into the data transmission between the VMs and the remote storage devices.
